(19) United States
(12) Patent Application Publication
(10) Pub. No.: US 2003/0170352 A1
(43) Pub. Date: Sep. 11, 2003

(54) Fresh meat packaging system

(76) Inventors: Brian L. Owen, Abernathy, TX (US); Bradley D. Price, Plainview, TX (US)

Correspondence Address: CHIEF INTELLECTUAL PROPERTY COUNSEL, CARGILL, INCORPORATED, 15407 MCGINTY ROAD WEST, WAYZATA, MN, 55391-2399, US

(21) Appl. No.: 10/093,872

(22) Filed: Mar. 8, 2002

(51) Int. Cl. A23B 4/00

(52) U.S. Cl. 426/129

(57) ABSTRACT

A packaging system for a fresh meat product is disclosed. The packaging system includes a tray having a base and a wall defining an interior space. The tray has an outward protruding lip extending generally around a perimeter of an upper portion of the wall. An oxygen permeable film surrounds the tray and covers the interior space. The film further defines a second space external to the tray between the outward protruding lip and the base. The protruding lip has at least one channel, the channel connecting the interior space to the second space. The oxygen permeable film includes openings sized to allow exchange of gases between the second space and the surrounding atmosphere.

### BACKGROUND OF THE INVENTION

The present invention relates to a fresh meat packaging system. More particularly, it relates to a retail, case-ready package and a method of packaging fresh meat in a controlled atmosphere, to extend the shelf life of packaged meat products.

Fresh meat products are typically processed from primals to various cuts in a meat processing facility, and then packaged in controlled atmospheric conditions for shipment directly to a retailer, such as a grocery store or supermarket. One typical meat packaging technique includes placing the cuts on styrofoam trays, which are then overwrapped with a permeable clear plastic film. These overwrapped trays are then placed within a vacuum-packed and gas-flushed barrier bag.

In the case of red meat, controlled exposure of the meat product to oxygen is necessary to oxygenate the meat pigment to bright red oxymyglobin. This controlled oxygen exposure results in a desired “bloom” of the meat to a bright red color, which the typical retail customer associates with freshness. However, in the case of red meat, prolonged exposure to oxygen causes the conversation of myoglobin meat pigmentation to metmyoglobin having a gray or brown color that is generally considered undesirable to the typical retail customer. Furthermore, prolonged exposure of fresh meat to oxygen also often causes bacterial decay of the meat product.

To prevent discoloration and extend the shelf life of meat products, modified atmosphere packaging techniques are used. For example, U.S. Pat. Nos. 5,667,827 and 5,711,978 to Breen et al. disclose a package and process for packaging fresh meat in a substantially oxygen-free atmosphere. The Breen patents disclose use of a tray that is ventilated with holes and overwrapped with a plastic wrapping material that includes slits to allow exchange of gases with the external atmosphere. These patents disclose placing a number of these trays within a barrier bag that is evacuated and flushed with carbon dioxide and then sealed. The outer barrier bag prevents oxygen from reaching the meat products and causing bacterial decay or discoloration. When the retailer is ready to display the meat product in a display case, the outer bag is removed, which allows oxygen from the atmosphere to reach the meat product and cause the meat product to bloom.

One problem associated with this system is that the gas barrier meat tray includes openings through a side or end wall, which allows purge from the meat product to leak from the tray and which are susceptible to blockage by movement of the meat product within the tray. The purge can also then leak through the perforations in the film onto the meat display case. These problems are exacerbated in a typical meat display case, where packages containing meat cuts are often placed in the case at an angle to enhance the consumer's ability to adequately view the product.

There is a need in the art for a fresh meat packaging system that would extend the storage life of meat products and allow the meat products to properly bloom by allowing oxygen from the atmosphere to reach the meat product located in the tray, while preventing purge from leaking from the tray.

### BRIEF SUMMARY OF THE INVENTION

The present invention, in one embodiment, is a fresh meat packaging system. The packaging system includes a tray having a base and a wall defining an interior space. The tray has an outward protruding lip extending generally around a perimeter of an upper portion of the wall. A film surrounds the tray and covers the interior space. The film further defines a second space external to the tray between the outward protruding lip and the base. The protruding lip has at least one channel located in the wall, the channel connecting the interior space to the second space. The film includes openings sized to allow exchange of gases between the second space and the surrounding atmosphere.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a perspective view of a film-covered fresh meat packaging system according to one embodiment of the present invention.

FIG. 2 is a bottom plan view of the packaging tray of FIG. 1.

FIG. 3 is an end plan view of the film-covered meat packaging system of FIG. 1.

FIG. 4 is a perspective view of a packaging tray according to another embodiment of the present invention.

### DETAILED DESCRIPTION

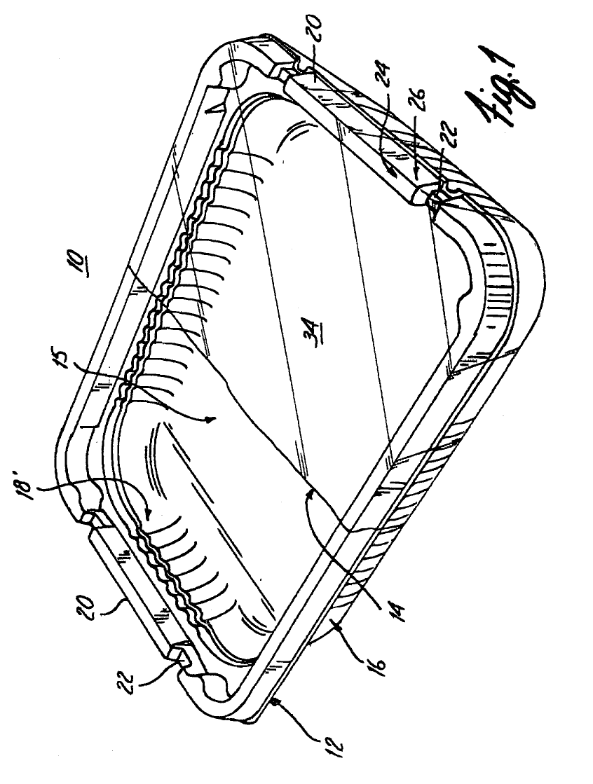

FIG. 1 shows a top perspective view of a fresh meat packaging system 10. As shown in FIG. 1, the packaging system 10 includes a tray 12 and a film 14. For purposes of illustration, the film 14 is shown in a cut-away view. In a complete packaging system 10, the film 14 covers the entire tray 12. In one embodiment of the present invention, the tray 12 is constructed from a material that is impermeable to oxygen. In various embodiments, the tray 12 is constructed from a thermoplastic, such as polyvinyl, polypropylene, and polystyrene. In one embodiment, the tray 12 is fabricated using an injection molding process. The film 14 is a plastic wrapping material or film. In one embodiment, the film 14 is oxygen permeable.

As shown in FIG. 1, the tray 12 includes a base 15 and a pair of generally opposing sidewalls 16 and generally opposing endwalls 18. Near a top surface of the tray 12, the sidewalls 16 and endwalls 18 meet to form a lip 20 extending around the perimeter of the upper surface of the tray 12. In other embodiments of the present invention, the tray includes a single wall extending around the periphery of the base 15. As shown in FIG. 1, the lip 20 is generally U-shaped with an open side facing downward. The lip 20 includes one or more channels 22 located on one or both of the endwalls 18 of the tray 12. As shown in FIG. 1, in one embodiment, the tray 12 includes four such channels 22. As shown, the channels 22 are located away from the sidewalls 16. The channels 22 in the lip 20 extend both downward from an upper surface 24 and inward from an outer lip surface 26. This configuration of the channel 22 in combination with the film 14 defines a passage extending from the inside to the outside of the tray 12.

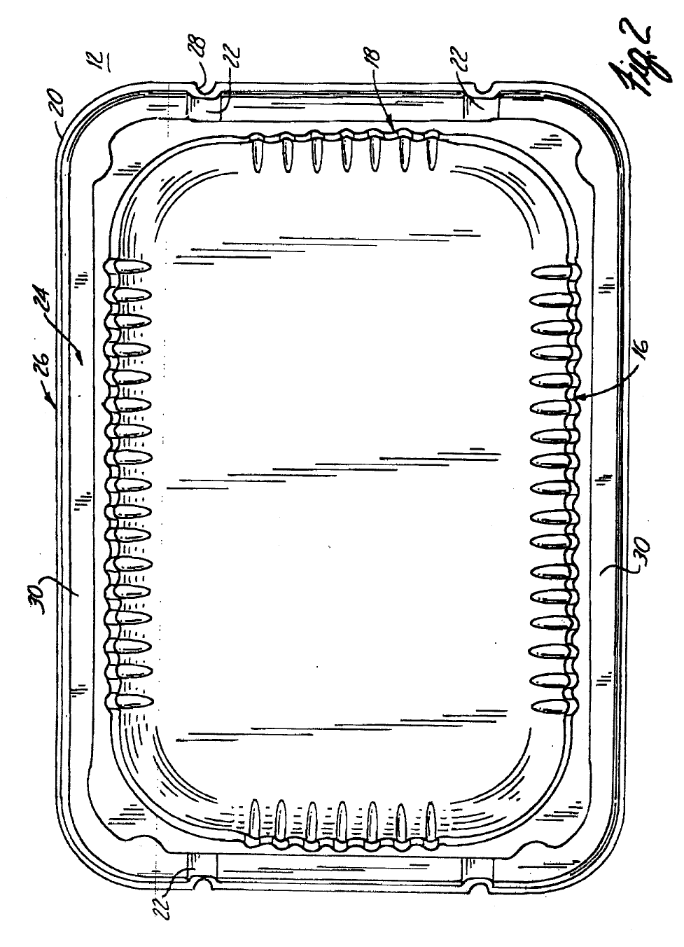

FIG. 2 is a bottom plan view of the tray 12. FIG. 2 shows the lip 20 extending generally around the periphery of the tray 12. As shown, the channels 22 include an inward channeled-groove 28 into the outer wall 26 of the lip 20. The walls 16 and 18, together with the upper surface 24 and the outer surface 26 of the lip 20, define a plenum 30 extending around the entire periphery of the tray 12. As shown, in this embodiment, the plenum 30 is open to the outside of the tray 12. In another embodiment, the lip 20 further includes a lower surface, which acts to enclose the plenum 30.

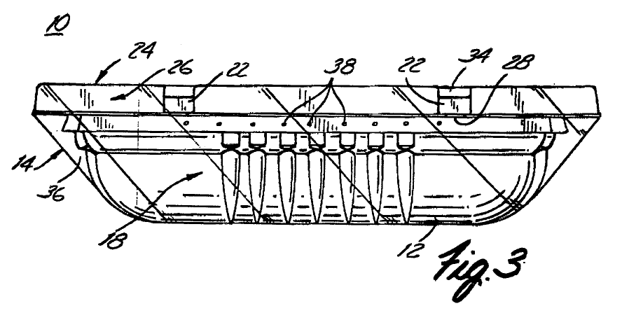

FIG. 3 is a plan view of an end of the meat packaging system 10. As shown in FIG. 3, the tray 12 and the film 14 define two enclosed spaces. An inner enclosed space 34 (also shown in FIG. 1) is defined by the hollow interior surface of the tray 12 and the film 14 extending across the top of the tray 12 supported by the lip 20. An outer enclosed space 36 is defined by an exterior surface of the tray 12 and the portion of the film 14 extending from the outer surface 26 of the lip 20 to a bottom surface of the tray 12. As shown in FIG. 3, the outer enclosed space 36 extends around the entire external periphery of the tray 12. The inner enclosed space 34 and the outer enclosed space 36 are connected to one another through the channels 22. As further shown in FIG. 3, in one embodiment, the film 14 includes one or more openings 38 which enable gas communication between the outer enclosed space 36 and the atmosphere. In one embodiment, the one or more openings 38 are located only in the portions of the film 14 associated with the ends of the tray 12. In one embodiment, the openings 38 are located in the film 14 only along one side of the tray 12. In one embodiment, the openings 38 are located in the film 14 along a top side of the tray 12. In various embodiments, the openings 38 are holes, slits, or perforations in the film 14.

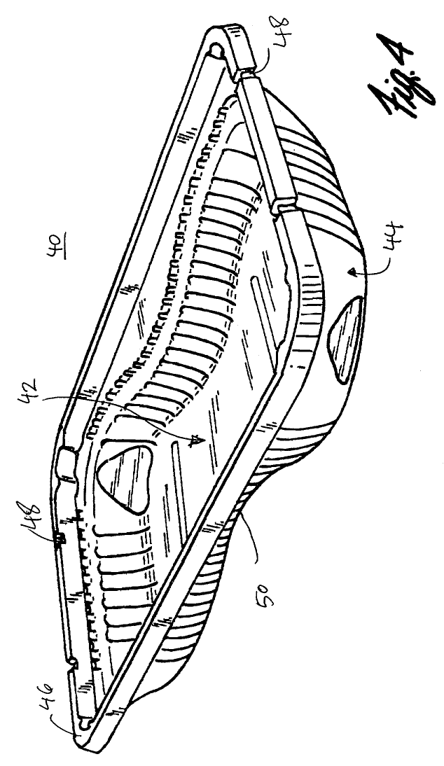

FIG. 4 shows a tray 40 according to another embodiment of the present invention. As shown in FIG. 4, the tray 40 includes a base 42 a wall 44 and a lip 46. The lip 46 includes one or more channels 48 located on one or both ends of the tray 40. As shown in FIG. 4, in one embodiment, the tray 40 includes four such channels 48. The channels 48 in the lip 46 extend both downward from an upper surface of the lip and inward from an outer surface of the lip. As further shown in FIG. 4, the wall 44 is generally hourglass-shaped, such that the wall 44 forms a waist 50 near a longitudinal midpoint of the tray 40.

During use of the fresh meat packaging system 10, pre-fabricated cuts of meat product are placed into the tray 12. In one embodiment, a soaker pad is placed beneath the meat product. Next, both the tray 12 and the meat product are wrapped with film 14. In one embodiment of the present invention, the film 14 is heat sealed. In one embodiment, the tray 12 is not wrapped, but rather is enclosed in the film 14. Next, the openings 38 are made in the film 14 in an area outside of the tray 12. In one embodiment, the openings 38 are placed in the film 14 prior to placement around the tray 12. In one embodiment, the openings 38 are placed just below the outer surface 26 of the lip 20. In one embodiment, the openings are placed just below the outer surface 26 of the portion of the lip 20 supported by the endwalls 18. In one embodiment, the openings 38 extend through both the film 14 and the outer surface 26 of the lip 20. In one embodiment, the openings 38 are placed about half-way between the lip 20 and the bottom surface of the tray 12. In one embodiment, the openings 38 are placed along a top endwall 18, such that when the tray 12 is placed upright in the display case, any purge from the meat product will not leak through the openings 38.

In one embodiment, approximately fifteen to approximately thirty-five opening 38 are placed generally in a line extending between the endwalls 18. In one embodiment, approximately thirty to thirty-five openings 38 are placed generally in a line extending between the endwalls 18. In one embodiment, the opening 38 are placed in any other configuration and location limited only by the requirement that the openings 38 extend into the outer enclosed space 36. In one embodiment, the openings 38 have an initial, pre-heat-shrink diameter ranging in size from about fifteen to about fifty mils. In one embodiment, the initial, pre-heat-shrink diameter of the openings 38 is between thirty and forty mils. In one embodiment, the size of the openings 38 is directly proportional to the volume of the inner enclosed space 34, such that a larger volume tray has a larger opening 38 diameter.

In one embodiment, the film 14 is then subjected to a heat-shrink process to place a tension on the film 14 surrounding the tray 12. This tension, helps prevent the film 14 from collapsing onto the meat product located inside the enclosed space 34. By creating tension in the film 14, the heat-shrink process also results in an increase in the diameter of the openings 38. In one embodiment, the diameter of the openings 38, after completion of the heat-shrink process is approximately fifty to approximately ninety mils. In one embodiment, the diameter of the openings 38, after completion of the heat-shrink process is approximately sixty to approximately eighty mils.

The packaging system 10 is then placed inside a barrier bag (not shown) which is evacuated of atmospheric gases and flushed with a preservation enhancing gas, such as nitrogen or carbon dioxide. During this evacuation process, gases in the inner enclosed space 34 flow through the channels 22 into the outer enclosed space 36 and then through the openings 38 into the barrier bag. The channels 22 and openings 38 prevent the film 14 from collapsing on the meat product during the evacuation process. Likewise, any preservation enhancing gases introduced into the barrier bag enter the inner enclosed space 34 of the tray 12 using the same flow path. Any gases introduced into the barrier bag also enter the inner enclosed space 34 through the permeable film 14. In one embodiment, where the openings 38 are located only in a portion of the film 14 associated with one side of the tray 12, the evacuation process results in a residual oxygen level in the inner enclosed space 34 of less than about 250 ppm.

Next, the barrier bags containing individual covered trays are shipped to the retailer. When the retailer receives the package, he removes the meat packaging system 10 from the outer barrier bag. This allows atmospheric gases, including oxygen to flow into the outer enclosed space 36 through the openings 38. These gases then flow from the outer enclosed space 36 into the enclosed inner space 34 through the one or more channels 22. Simultaneously, the atmospheric gasses enter the inner enclosed space 34 through the permeable film 14. This process gradually increases the oxygen content within the first enclosed space 34, which allows the cut of meat therein to bloom.

Because of the design of the meat packaging system 10, the retailer can place the packaging system 10 in the retail case in a vertical or generally vertical fashion. The absence of any perforations or holes on the walls 16, 18 of the tray 12 ensures that any purge from the meat product remain contained within the enclosed inner space 34. The placement of the channel 22 on the lip 20 prevents the channel 22 from becoming blocked by purge from the meat product, and thus allows the inner enclosed space 34 to continue to exchange gases with the atmosphere. Placement of the openings 38 through the film 14 into the outer enclosed space 36 ensures that the openings 38 will not become blocked by purge or by the meat product itself.

Although the present invention has been described with reference to preferred embodiments, persons skilled in the art will recognize that changes may be made in form and detail without departing from the spirit and scope of the invention.

We claim:

1. A fresh meat packaging system comprising:
a tray having a base and a wall defining an internal space, the tray having an outward protruding lip extending generally around a perimeter of an upper portion of the wall;
a film surrounding the tray, the film covering the internal space and defining an external space external to the tray between the outward protruding lip and the base;
the protruding lip having at least one channel therein, the channel connecting the internal space to the external space; and
the film including at least one opening sized to allow exchange of gases between the external space and the surrounding atmosphere.

2. The system of claim 1 wherein the wall includes two generally opposed endwalls and two generally opposed sidewalls, and further wherein the at least one channel is located in at least one of the endwalls.

3. The system of claim 2 wherein the protruding lip has two channels located in each of the two end walls.

4. The system of claim 1 wherein the tray is constructed from an injection molded thermoplastic.

5. The system of claim 1 wherein the protruding lip includes an upper surface and an outer surface, which together with the wall, define a plenum extending around the periphery of the tray.

6. The system of claim 5 wherein the channel includes a first channeled-groove in the upper surface and a second channeled-groove in the outer surface.

7. The system of claim 1 wherein the at least one opening in the film are located at about half the distance between the protruding lip and the base.

8. The system of claim 7 wherein the at least one opening includes a first plurality of openings located near a first end wall and a second plurality of openings located near a second end wall.

9. The system of claim 5 wherein the protruding lip further includes a bottom surface, which together with the wall, the upper surface and the outer surface, define an enclosed plenum extending around the periphery of the tray.

10. The system of claim 1 wherein the film is constructed from an oxygen permeable material.

11. The system of claim 1 wherein the at least one opening includes about fifteen to about thirty-five openings having a diameter of about sixty to about eighty mils, and the openings are located generally along a line in a portion of the film corresponding to a first side of the tray.

12. The system of claim 11 wherein the opening are located only in the portion of the film.

13. A retail fresh meat package comprising:
a tray having a base, two generally opposed side walls, and two generally opposed end walls defining an interior space, the tray having an outward protruding lip extending generally around a perimeter of an upper portion;
a fresh meat product located in the interior space of the tray;
an oxygen permeable film surrounding the tray and the fresh meat product, the film covering the interior space and defining a second space external to the tray between the outward protruding lip and the base;
the protruding lip having at least one channel located in a portion of the lip partially defined by at least one of the end walls, the channel connecting the interior space to the second space; and
the oxygen permeable film further including a plurality of openings sized to allow exchange of gases between the second space and the surrounding atmosphere.

14. The package of claim 13 wherein the protruding lip has two channels located in a portion of the lip partially defined by each of the two end walls.

15. The package of claim 13 wherein the tray is constructed from an injection molded thermoplastic.

16. The package of claim 13 wherein the protruding lip includes an upper surface and an outer surface, which together with the wall, define a plenum extending around the periphery of the tray.

17. The package of claim 13 wherein the at least one channel includes a first channeled-groove in the upper surface and a second channeled-groove in the outer surface.

18. The package of claim 13 wherein the plurality of openings in the film are located adjacent to the protruding lip.

19. The package of claim 13 wherein the plurality of openings include about fifteen to about thirty-five openings located along a first sidewall.

20. The package of claim 13 wherein the plurality of openings have a diameter of about sixty to about eighty mils.
